(19) United States
(12) Patent Application Publication
(10) Pub. No.: US 2005/0050735 A1
(43) Pub. Date: Mar. 10, 2005

(54) Cutter device having spare cutter blades

(76) Inventor: Yin Han Huang, Taichung (TW)

Correspondence Address: Yin Han Huang, P.O. Box 63-99, Taichung, 406, TW

(21) Appl. No.: 10/657,674

(22) Filed: Sep. 5, 2003

(51) Int. Cl. B26B 17/00

(52) U.S. Cl. 30/186

(57) ABSTRACT

A cutter device includes two plier levers pivotally coupled together, and each having a handle section on one end and an operating member on opposite end. The handle section of one of the plier levers includes a chamber to receive one or more spare blades. A handle shell is slidably engaged onto the handle section. A lock device may releasably lock the handle shell to the handle section. A casing is receivable in the handle section to receive the spare blades, and includes a resilient catch to engage through the handle section and to detachably engage and anchor the handle shell to the handle section when the handle shell is engaged onto the handle section.

### BACKGROUND OF THE INVENTION

1. Field of the Invention

The present invention relates to a plier or cutter device, and more particularly to a cutter device having a casing received in one of the handles to receive spare cutter blades.

2. Description of the Prior Art

Various kinds of typical plier or cutter devices have been developed for cutting work pieces, and comprise a pair of plier arms pivotally or rotatably coupled together with a pivot pin at the middle portion thereof. Each of the plier arms includes a handle section provided on one end thereof, and a cutter or anvil member provided on the other end thereof for cutting purposes.

For example, U.S. Pat. No. 6,098,225 to McIntosh et al. discloses one of the typical plier or cutter devices comprising a pair of plier arms each including a middle portion pivotally or rotatably coupled together with a pivot pin. Each of the plier arms includes a handle section provided on one end thereof, and a cutter member provided on the other end thereof for cutting purposes; and further includes one or more knife blades pivotally attached to the handle section thereof. However, the cutter members may not be changed with the new ones when the cutter members have been worn out or damaged.

U.S. Pat. No. 6,260,279 to Apolinski et al. discloses another typical plier or cutter device also comprising a pair of plier arms each including a middle portion pivotally or rotatably coupled together with a pivot pin. Each of the plier arms includes a handle section provided on one end thereof, and a cutter member and an anvil member provided on the other end thereof for cutting purposes. One of the handle sections of the plier arms includes one or more spare blades received in the handle section, and a handle shell pivotally attached to the handle section, to retain the spare blades within the handle section. However, due to limited spaces, the handle shell may only be rotated away from the handle section for a limited angle, such that the handle section may not be fully opened, and such that the spare blades may not be easily fetched or obtained by the users.

The present invention has arisen to mitigate and/or obviate the afore-described disadvantages of the conventional plier or cutter devices.

### SUMMARY OF THE INVENTION

The primary objective of the present invention is to provide a cutter device including a casing received in one of the handles to receive spare cutter blades.

The other objective of the present invention is to provide a cutter device including a shell slidably engaged onto the handle to retain the casing within the handle, and to allow the casing to be easily obtained by the users.

In accordance with one aspect of the invention, there is provided a cutter device comprising a first plier lever and a second plier lever including a middle portion pivotally coupled together with a pivot pin, to allow the first and the second plier levers to be rotated relative to each other, the first and the second plier levers each including a handle section provided on one side of the pivot pin, and an operating member provided on opposite side of the pivot pin, the handle section of the second plier lever including a chamber formed therein, at least one spare blade received in the chamber of the handle section of the second plier lever, a handle shell including a channel formed therein to slidably receive the handle section of the second plier lever, and slidable and engageable onto the handle section to selectively enclose the chamber of the handle section of the second plier lever, and to detachably receive the spare blade in the chamber of the handle section of the second plier lever, and the handle shell being slidable relative to the handle section to selectively and fully open the chamber of the handle section of the second plier lever, and to allow the spare blade to be easily removed from the chamber of the handle section of the second plier lever. A lock device may further be provided for releasably locking the handle shell to the handle section of the second plier lever.

A casing may further be provided and receivable in the chamber of the handle section of the second plier lever, to receive the spare blade therein. The casing includes a space formed therein to receive the spare blade therein, and a spring member received in the space thereof, and engaged with the spare blade, to bias the spare blade upwardly against an upper board of the casing.

The casing includes a front board having a slit formed therein and communicating with the space of the casing, to disengage the spare blade from the casing. The upper board of the casing includes an opening formed therein, to partially expose the space of the casing and to allow the spare blade to be disengaged from the casing.

The releasably lock device includes a resilient catch extended from the casing, to engage through the handle section of the second plier lever, and to detachably engage and anchor the handle shell to the handle section of the second plier lever.

The handle section of the second plier lever includes a bottom board to define the chamber thereof, the bottom board includes an opening formed therein, and the handle shell includes an aperture formed therein, the resilient catch of the casing is engageable through the opening of the bottom board of the handle section of the second plier lever, and engageable into the aperture of the handle shell, to detachably anchor the handle shell to the handle section of the second plier lever.

The handle section of the second plier lever includes a longitudinal groove formed therein, the handle shell includes a rod secured thereto and slidably engaged in the longitudinal groove of the handle section of the second plier lever, to limit a movement of the handle shell relative to the handle section of the second plier lever, and to prevent the handle shell from being disengaged from the handle section of the second plier lever.

The handle section of the second plier lever includes a bottom board to define the chamber thereof, the bottom board includes a width smaller than that of the handle section of the second plier lever, to form the longitudinal groove of the handle section of the second plier lever beside the bottom plate.

The handle shell includes at least one ear extended in the channel thereof and engageable with the handle section of the second plier lever, to stably guide the handle shell to move relative to the handle section of the second plier lever. The handle section of the second plier lever includes a guide rib extended thereon, the ear of the handle shell includes a recess formed therein to slidably receive the guide rib of the handle section of the second plier lever, and to stably guide the handle shell to move relative to the handle section of the second plier lever.

The handle section of the second plier lever includes a passage formed therein, and an angle wrench received in the passage of the handle section of the second plier lever. The ear of the handle shell includes a depression formed therein to receive the angle wrench and to detachably retain the angle wrench in the handle section of the second plier lever.

The operating member of the first plier lever is an anvil member. The operating member of the second plier lever is a cutter member. The second plier lever includes a base panel provided thereon to support the cutter member, a retaining panel engaged onto the cutter member and secured to the base panel, to detachably secure the cutter member to the second plier lever.

A lock device may further be provided to selectively lock the first and the second plier levers together. The first plier lever includes a lock notch formed therein, the lock device includes a first end pivotally secured to the second plier lever, and a second end for selectively engaging into the lock notch of the first plier lever, to selectively lock the first and the second plier levers together.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a plier or cutter device in accordance with the present invention;

FIG. 2 is a perspective view of the cutter device;

FIG. 3 is a top plan view of the cutter device, in which a portion of the handle shell is cut off to show an inner structure of the handle;

FIG. 4 is a partial cross sectional view taken along lines 4-4 of FIG. 3;

FIG. 5 is a partial cross sectional view similar to FIG. 4, illustrating the operation of the cutter device; and

FIG. 6 is a top plan view similar to FIG. 3, illustrating the operation of the cutter device.

### DETAILED DESCRIPTION OF THE PREFERRED EMBODIMENT

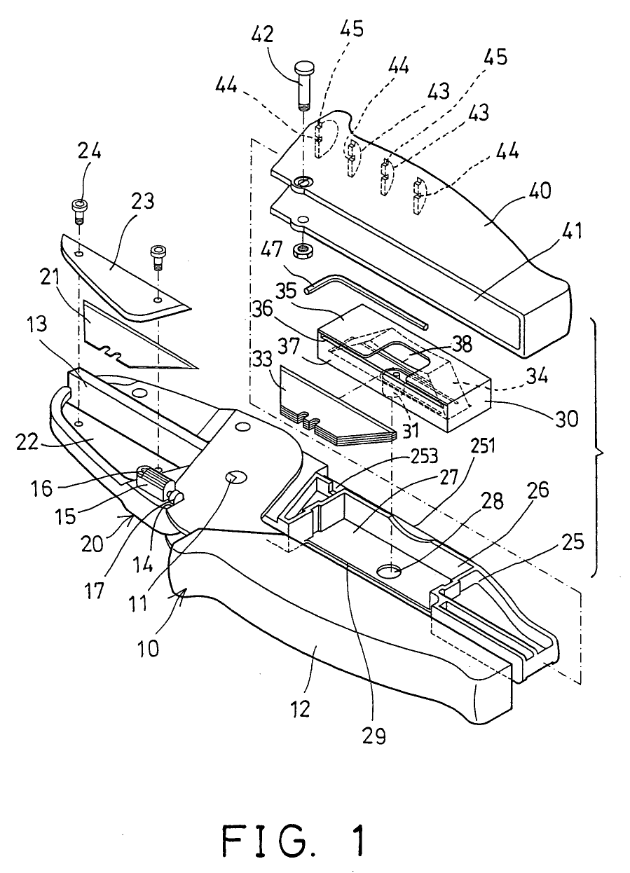

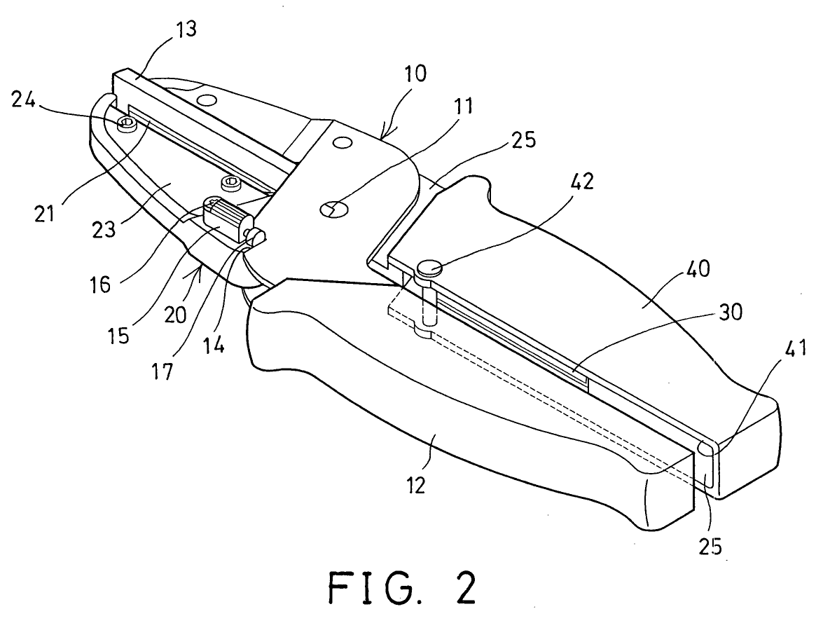

Referring to the drawings, and initially to FIGS. 1-3, a cutter device in accordance with the present invention comprises a pair of plier levers 10, 20 each including a middle portion pivotally or rotatably coupled together with a pivot pin 11, to allow the plier levers 10, 20 to be rotated relative to each other.

One of the plier levers 10 includes a handle section 12 provided on one side of the pivot pin 11, and an operating member 13, such as an anvil member 13 provided on the other side or the opposite side of the pivot pin 11. The plier lever 10 includes a lock notch 14 formed or provided in the middle portion thereof.

The other plier lever 20 includes an operating member 21, such as a cutter member 21 attached or provided on one end thereof, and arranged corresponding to or close to the anvil member 13 of the plier lever 10, for being moved or forced onto or against the anvil member 13 of the plier lever 10, in order to conduct cutting operations.

For example, the other plier lever 20 includes a base panel 22 provided on the one end thereof (FIG. 1) to support the cutter member 21 thereon, and a retaining panel 23 engaged onto the cutter member 21, and secured to the base panel 22 with such as fasteners 24, to detachably or replaceably secure the cutter member 21 on the one end of the plier lever 20, and to allow the cutter member 21 to be changed with the new ones when the cutter member 21 has been worn out or damaged.

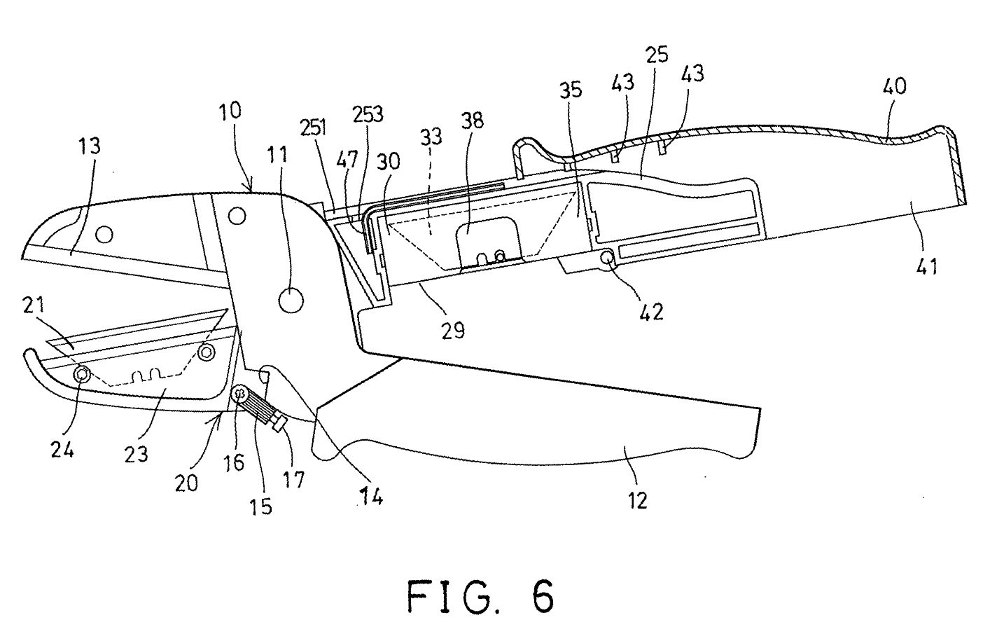

The other plier lever 20 further includes a lock device 15 having one end pivotally secured to the middle portion thereof with a pivot axle 16, and the other end 17 for engaging into the lock notch 14 of the plier lever 10 (FIGS. 1-3), to selectively lock the plier levers 10, 20 together, and to prevent the plier levers 10, 20 from being operated by the users. The plier levers 10, 20 may be operated by the users again when the lock device 15 is disengaged from the lock notch 14 of the plier lever 10 (FIG. 6).

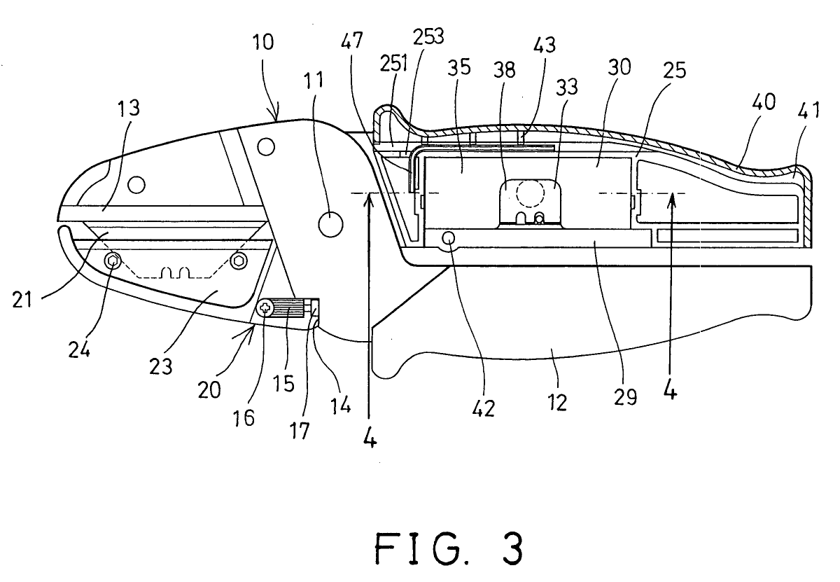

The other plier lever 20 includes a handle section 25 provided on the other end thereof (FIGS. 1, 3, 6), and having a chamber 26 formed therein, such as formed in the middle portion thereof, and defined by a bottom plate 27 which includes an orifice 28 formed therein. The bottom plate 27 includes a width smaller than that of the handle section 25, to form a longitudinal groove 29 in the handle section 25 and beside the bottom plate 27, best shown in FIGS. 3 and 6.

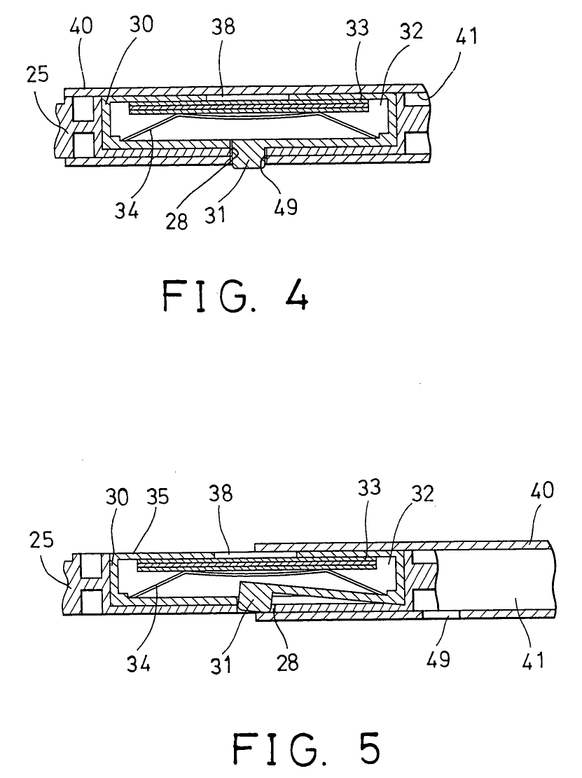

A casing 30 is received in the chamber 26 of the handle section 25, and includes a spring-biased or resilient catch 31 provided or extended downwardly therefrom, to extend or engage through the orifice 28 of the bottom plate 27 of the handle section 25, and to detachably anchor or lock the casing 30 to the handle section 25 of the plier lever 20, best shown in FIGS. 4 and 5.

The casing 30 includes a space 32 formed therein (FIGS. 4, 5) to receive one or more spare blades 33 therein, and a spring member 34 received in the space 32 of the casing 30, and engaged with the spare blades 33, to bias the spare blades 33 upwardly against an upper board 35 of the casing 30.

The casing 30 includes a slit 36 formed in the upper portion of the front board 37 thereof (FIG. 1), to allow the spare blades 33 to be removed from the casing 30. The upper board 35 of the casing 30 includes an opening 38 formed therein, to partially expose the space 32 of the casing 30 or the spare blades 33, and to allow the spare blades 33 to be easily disengaged or removed from the casing 30.

A handle shell 40 includes a channel 41 formed therein to slidably receive the handle section 25 of the plier lever 20, and includes a rod 42 secured thereto. The rod 42 is slidably engaged in the longitudinal groove 29 of the handle section 25 (FIG. 3), and engageable with the handle section 25 (FIG. 6), to limit the movement of the handle shell 40 relative to the handle section 25, and to prevent the handle shell 40 from being disengaged from the handle section 25.

The handle section 25 of the plier lever 20 further includes a guide rib 251 extended on the outer portion thereof (FIGS. 1, 3, 6), and the handle shell 40 includes one or more ears 43 extended in the channel 41 thereof and each having a recess 44 formed therein (FIG. 1), to slidably receive the guide rib 251 of the handle section 25, and to stably guide the handle shell 40 to move relative to the handle section 25, and to prevent the handle shell 40 from being tilted or vibrated or shacken relative to the handle section 25.

The handle section 25 of the plier lever 20 further includes a passage 253 formed therein (FIGS. 1, 3, 6) to slidably or detachably receive an angle wrench 47 therein. Each of the ears 43 of handle shell 40 further includes a depression 45 formed therein (FIG. 1), to further slidably receive the angle wrench 47 therein, and to further detachably retain the angle wrench 47 in the handle section 25.

As shown in FIGS. 4 and 5, the handle shell 40 further includes an aperture 49 formed in the bottom portion thereof, to selectively or detachably receive the spring-biased or resilient catch 31 of the casing 30, and to detachably or openably or releasably lock the handle shell 40 to the handle section 25.

In operation, as shown in FIG. 5, when the spring-biased or resilient catch 31 of the casing 30 is depressed against or into the aperture 49 of the handle shell 40, the handle shell 40 may be moved or slid relative to the handle section 25, in order to fully open the chamber 26 of the handle section 25 (FIG. 6), and thus to allow the casing 30 to be easily removed from the chamber 26 of the handle section 25.

When the casing 30 is engaged into the chamber 26 of the handle section 25 again, and when the handle shell 40 is moved or slid and engaged onto the handle section 25 again, the spring-biased or resilient catch 31 of the casing 30 may be engaged into the aperture 49 of the handle shell 40 again when the spring-biased or resilient catch 31 of the casing 30 is aligned with the aperture 49 of the handle shell 40 again (FIG. 4).

It is to be noted that the handle shell 40 is slidably engaged onto the handle section 25 of the plier lever 20, to selectively enclose the chamber 26 of the handle section 25, and is also slidable relative to the handle section 25, and to allow the chamber 26 of the handle section 25 to be fully opened, and thus to allow the casing 30 or the spare blades 33 to be easily obtained by the users.

Accordingly, the cutter device in accordance with the present invention includes a casing received in one of the handles to receive spare cutter blades, and includes a shell slidably engaged onto the handle to retain the casing within the handle, and to allow the casing to be easily obtained by the users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A cutter device comprising:
a first plier lever and a second plier lever including a middle portion pivotally coupled together with a pivot pin, to allow said first and said second plier levers to be rotated relative to each other,
said first and said second plier levers each including a handle section provided on one side of said pivot pin, and an operating member provided on opposite side of said pivot pin, said handle section of said second plier lever including a chamber formed therein,
at least one spare blade received in said chamber of said handle section of said second plier lever,
a handle shell including a channel formed therein to slidably receive said handle section of said second plier lever, and slidable and engageable onto said handle section to selectively enclose said chamber of said handle section of said second plier lever, and to detachably receive said at least one spare blade in said chamber of said handle section of said second plier lever, and
said handle shell being slidable relative to said handle section to selectively and fully open said chamber of said handle section of said second plier lever, and to allow said at least one spare blade to be easily removed from said chamber of said handle section of said second plier lever, and
means for releasably locking said handle shell to said handle section of said second plier lever.

2. The cutter device as claimed in claim 1 further comprising a casing receivable in said chamber of said handle section of said second plier lever, to receive said at least one spare blade therein.

3. The cutter device as claimed in claim 2, wherein said casing includes a space formed therein to receive said at least one spare blade therein, and a spring member received in said space thereof, and engaged with said at least one spare blade, to bias said at least one spare blade upwardly against an upper board of said casing.

4. The cutter device as claimed in claim 3, wherein said casing includes a front board having a slit formed therein and communicating with said space of said casing, to disengage said at least one spare blade from said casing.

5. The cutter device as claimed in claim 4, wherein said upper board of said casing includes an opening formed therein, to partially expose said space of said casing and to allow said at least one spare blade to be disengaged from said casing.

6. The cutter device as claimed in claim 2, wherein said releasably locking means includes a resilient catch extended from said casing, to engage through said handle section of said second plier lever, and to detachably engage and anchor said handle shell to said handle section of said second plier lever.

7. The cutter device as claimed in claim 6, wherein said handle section of said second plier lever includes a bottom board to define said chamber thereof, said bottom board includes an opening formed therein, and said handle shell includes an aperture formed therein, said resilient catch of said casing is engageable through said opening of said bottom board of said handle section of said second plier lever, and engageable into said aperture of said handle shell, to detachably anchor said handle shell to said handle section of said second plier lever.

8. The cutter device as claimed in claim 1, wherein said handle section of said second plier lever includes a longitudinal groove formed therein, said handle shell includes a rod secured thereto and slidably engaged in said longitudinal groove of said handle section of said second plier lever, to limit a movement of said handle shell relative to said handle section of said second plier lever, and to prevent said handle shell from being disengaged from said handle section of said second plier lever.

9. The cutter device as claimed in claim 8, wherein said handle section of said second plier lever includes a bottom board to define said chamber thereof, said bottom board includes a width smaller than that of said handle section of said second plier lever, to form said longitudinal groove of said handle section of said second plier lever beside said bottom plate.

10. The cutter device as claimed in claim 1, wherein said handle shell includes at least one ear extended in said channel thereof and engageable with said handle section of said second plier lever, to stably guide said handle shell to move relative to said handle section of said second plier lever.

11. The cutter device as claimed in claim 10, wherein said handle section of said second plier lever includes a guide rib extended thereon, said at least one ear of said handle shell includes a recess formed therein to slidably receive said guide rib of said handle section of said second plier lever, and to stably guide said handle shell to move relative to said handle section of said second plier lever.

12. The cutter device as claimed in claim 1, wherein said handle section of said second plier lever includes a passage formed therein, and an angle wrench received in said passage of said handle section of said second plier lever.

13. The cutter device as claimed in claim 12, wherein said handle shell includes at least one ear extended in said channel thereof and having a depression formed therein to receive said angle wrench and to detachably retain said angle wrench in said handle section of said second plier lever.

14. The cutter device as claimed in claim 1, wherein said operating member of said first plier lever is an anvil member.

15. The cutter device as claimed in claim 1, wherein said operating member of said second plier lever is a cutter member.

16. The cutter device as claimed in claim 15, wherein said second plier lever includes a base panel provided thereon to support said cutter member, a retaining panel engaged onto said cutter member and secured to said base panel, to detachably secure said cutter member to said second plier lever.

17. The cutter device as claimed in claim 1 further comprising a lock device to selectively lock said first and said second plier levers together.

18. The cutter device as claimed in claim 17, wherein said first plier lever includes a lock notch formed therein, said lock device includes a first end pivotally secured to said second plier lever, and a second end for selectively engaging into said lock notch of said first plier lever, to selectively lock said first and said second plier levers together.
